(19) United States
(12) Patent Application Publication
(10) Pub. No.: US 2021/0240364 A1
(43) Pub. Date: Aug. 5, 2021

(54) STORING NEW SETTINGS FOR WRITE-PROTECTED SYSTEMS ON NON-WRITE-PROTECTED STORAGE

(71) Applicant: HEWLETT-PACKARD DEVELOPMENT COMPANY, L.P., Spring, TX (US)

(72) Inventor: Irwan HALIM, Spring, TX (US)

(73) Assignee: Hewlett-Packard Development Company, L.P., Spring, TX (US)

(21) Appl. No.: 17/049,037

(22) PCT Filed: Jul. 10, 2018
(86) PCT No.: PCT/US2018/041471

§ 371 Date: Oct. 20, 2020

(51) Int. Cl. G06F 3/06

(52) U.S. Cl. CPC G06F 3/0622; G06F 3/0679; G06F 3/0655

(57) ABSTRACT

A system may comprise a processor and storage coupled to the processor. The storage may comprise write-protected storage and non-write-protected storage. The storage may store computer-readable instructions. When executed the computer-readable instructions may cause the processor to detect a new settings value to modify a setting from an existing settings value, the existing settings value stored on the write-protected storage, and store the new settings value in a settings file on the non-write-protected storage.

### BACKGROUND

Computer systems or applications that may run on computer systems may allow modification of settings. Some settings may be stored on write-protected storage.

### BRIEF DESCRIPTION OF THE DRAWINGS

Various examples will be described below referring to the following figures:

FIG. 1 shows a computer system with settings files stored in write-protected storage and non-write-protected storage in accordance with various examples;

FIG. 2 shows a networked environment including a computer system with settings files stored in write-protected storage and non-write-protected storage and settings values available across a network in accordance with various examples; and

FIG. 3 shows a method of detecting changes of settings corresponding to existing settings values stored on write-protected storage, storing new settings values on non-write-protected storage, and modifying settings during session initialization based on settings values on non-write-protected storage in accordance with various examples.

### DETAILED DESCRIPTION

Computer systems may use write-protected storage. This may be done as a security measure to prevent unwanted changes to the operating system and applications running on the computer system. The operating system and application settings may also be stored on write-protected storage. This may prevent a user from being able to readily customize the various settings on the computer system, as the settings may not be saved from session to session as the user logs in and out or reboots the system.

A settings manager may be executed on the computer system to allow a user to modify a selection of settings. These settings may be operating system settings or application settings determined to have minimal chance of adversely affecting the system. The settings manager may monitor the system for settings changes to existing settings values and store them as new settings values on non-write-protected storage. When the computer system is rebooted or a new session is started, the settings manager may modify the system settings from the existing settings values obtained from the write-protected storage to the new settings values saved to the non-write protected storage.

In one example in accordance with the present disclosure, a system is provided. The system comprises a processor and storage coupled to the processor, the storage comprising write-protected storage and non-write-protected storage, the storage to store computer-readable instructions and execution of the computer-readable instructions by the processor causes the processor to detect a new settings value to modify a setting from an existing settings value, the existing settings value stored on the write-protected storage and to store the new settings value in a settings file on the non-write-protected storage.

In one example in accordance with the present disclosure, a system is provided. The system comprises a processor and storage coupled to the processor, the storage comprising write-protected storage and non-write-protected storage, the storage to store computer-readable instructions and execution of the computer-readable instructions by the processor causes the processor to identify a settings file during initialization of a session, the settings file stored on the non-write-protected storage and to modify a setting from an existing settings value of the system to a new settings value during the initialization of the session, the existing settings value from the write-protected storage and the new settings value from the settings file.

In one example in accordance with the present disclosure, a system is provided. The system comprises a processor and storage coupled to the processor, the storage comprising write-protected storage and non-write-protected storage, the storage to store computer-readable instructions and execution of the computer-readable instructions by the processor causes the processor to detect a new settings value to modify a setting from an existing settings value, the existing settings value stored on the write-protected storage, to store the new settings value in a settings file on the non-write-protected storage, and to modify the setting from the existing settings value to the new settings value during the initialization of the session.

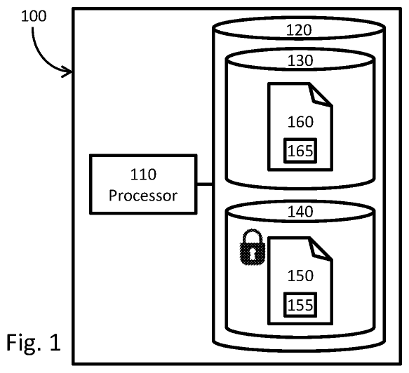

FIG. 1 shows a computer system 100 with settings files 150, 160 stored in write-protected storage 140 and non-write-protected storage 130, respectively, in accordance with various examples. Computer system 100 may include a processor 110 and storage 120 coupled together, such as via a bus. Storage 120 may include write-protected storage 140 and non-write-protected storage 130. The settings file 150 may include a settings value 155. The settings file 160 may include a settings value 165.

Computer system 100 may include a laptop computer, desktop computer, embedded system, virtual system, workstation, or remote desktop system. Storage 120 may include a disk drive, solid state drive, tape drive, Flash memory, a RAM (random access memory) drive, removable storage or other appropriate storage. In various examples, write-protected storage 140 may be write protected by the nature of the storage device, such as a read-only CD-ROM (compact disc-read only memory).

In various examples, write protected storage 140 may be write protected by a device driver such as by a write filter, an application, the operating system, the file system, or hardware write protection. The write protection may protect an entire device or portions of the device. For example, the write protection may prevent writing to a particular sector, file directory, or file. In various examples, the write protection may protect an entire storage device but have exceptions where writing may be performed to a designated sector, directory, or file.

In various examples, storage 120 may include a disk drive, write-protected storage 140 may include storage space on the disk drive that has write protection, and non-write-protected storage 130 may include storage space on the disk drive that does not have write protection. In various examples, storage 120 may comprise a combination of storage devices. For example, storage 120 may comprise a disk drive to provide non-write-protected storage 130 and Flash memory with write protection to provide write-protected storage 140.

Write-protected storage 140 may provide security for computer system 100. The write protection may protect against changes to computer-readable instructions or settings of computer system 100 by malicious attacks, such as by viruses or trojans, or to protect against a user changing the system, whether intentionally or unintentionally.

In various examples, write protection of write-protected storage 140 may be able to be disabled or suspended. For example, data may be written to write-protected storage 140 by supplying a password. An authorized user or a systems administrator may be able to disable or suspend the write protection for a time. Write protection may be re-enabled explicitly, after a set period of time, or at some other event, such as restarting or logging out of the computer system 100.

An application for execution on processor 110 may include computer-readable instructions stored on write-protected storage 140. The application may include a settings file 150 that stores a settings value 155. The settings value 155 may correspond to a setting of the application. The application may be of many varieties, such as a word processing application, a video game, a device driver for a programmable keyboard, or an operating system. The settings file 150 may be a file stored in a file directory structure of the write-protected storage 140. The application may read the settings value 155 from the settings file 150 during initialization of the application or when the setting is used by the application. The settings values in settings file 150, such as settings value 155, may be called existing settings values. A setting may be various values to configure the application, which may include settings for how the application operates or user settings. For example, a sales database application may include settings to refer to various network locations from which to draw data. The settings specifying those network locations may be configurable by a user, or they may be configurable by a systems administrator and unchangeable by a user. For example, a word processing application may include user settings, such as a customized dictionary, a set of saved styles, add-ons, or auto-correct settings. Modifying and saving these various settings may include saving a settings value 155 in a settings file 150 or in a registry entry, or both. The settings value 155 or the settings file 150 may be encrypted.

An application may be executed by processor 110. The application may store a settings value 155 in a settings file 150 on a write-protected storage 140. The settings value 155 may correspond to a user setting. If a user changes a user setting, the write protection on write-protected storage 140 may not allow the settings change to be stored to settings file 150 without a password, systems administrator assistance, or other process. Unless the change in setting is stored, the user's modification may not be preserved after a reboot or when initializing a new session on the computer system 100.

Processor 110 may execute a settings manager. The settings manager may be an application and may include computer-readable instructions stored on write-protected storage 140. The settings manager may detect a change in settings for another application. The settings manager may store a settings value 165 corresponding to the settings change in a settings file 160 on non-write-protected storage 130. Settings value 165 may be called a new settings value. The other application may be closed and re-opened, such as within the same user session, after logging out of the computer system 100, or after rebooting the computer system 100. The other application may be initialized and configured based on settings file 150 in the write-protected storage 140. The settings manager may detect that the other application is being initialized and identify a settings value 165 in settings file 160 that corresponds to the other application. The settings manager may modify the setting of the other application that corresponds to the settings value 165. The process of saving the settings value 165 to settings file 160 and restoring the corresponding setting to the application by the settings manager may involve user interaction with a user interface, or it may not be noticeable to a user. From a user's perspective, the operation may be indistinguishable from a system where settings file 150 of the application is stored on non-write-protected storage 130, instead of write-protected storage 140.

An application may allow programmatic modification of a settings file, such as by calling a function in an application programming interface (API) to change the setting. A setting may be modified by changing a known location in memory where the application stores the setting while in operation. Changing the setting of an application may include modifying a registry entry, such as by adding, deleting, or editing a registry entry. The registry may be saved to the write-protected storage 140. The settings manager may update an application's settings through an API call, modifying a location in memory, or modifying a registry entry. The settings manager may update the application's settings in other ways, depending on how the application manages and stores its settings.

The settings manager may detect when a setting of an application is modified. The settings manager may register with the application for an event notification on a change of setting. The settings manager may monitor file accesses to determine a write attempt is being made to settings file 155. The settings manager may otherwise interact with the application or operating system to detect when a setting of the application is changed. The settings manager may determine whether it manages that settings change. For example, a settings manager may manage a user's saved searches and default view settings for a database application, but not manage the source paths for the database information. If the settings manager manages a setting that is changed, it may record a corresponding settings value 165 in settings file 160 on non-write-protected storage 130. If the settings manager does not manage a setting that is changed, it may not record such a change. When the application is restarted, the application may configure its settings based on settings file 150 stored on write-protected storage 140. The settings manager may modify the application's settings based on settings file 160 on non-write-protected storage 130. If a user modifies a setting that is not managed by the settings manager, the application may use the settings value 155 stored in settings file 150 on the write-protected storage 140, and the settings manager may not store a modified setting in settings file 160 on the non-write-protected storage 130.

A systems administrator may configure the settings manager as to which settings of which applications are stored as settings values 165 in settings file 160 on non-write-protected storage 130. Such settings manager settings may be stored on write-protected storage 140, and a user may not be allowed to modify those settings manager settings. In various examples, the settings manager may manage its own settings.

In various examples, the application may include computer-readable instructions or settings stored on non-write-protected storage 130. The settings manager may include computer-readable instructions or settings stored on non-write-protected storage 130.

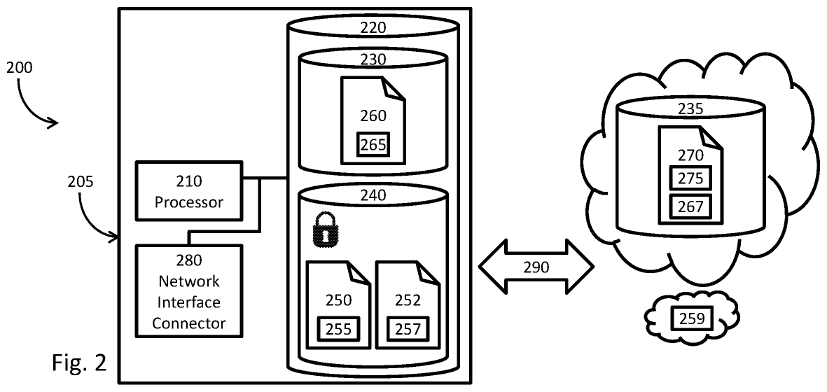

FIG. 2 shows a networked environment 200 including a computer system 205 with settings files 250, 252, 260, 270 stored in write-protected storage 240 and non-write-protected storage 230, 235 and settings values 259, 267, 275 available across a network 290 in accordance with various examples.

Networked environment 200 may include a computer system 205, a non-write-protected storage 235, such as a server, and a settings value 259 accessible across network 290. Computer system 205 may include a processor 210, a storage 220, and a network interface connector 280 coupled together, such as via a bus. Storage 220 may include write-protected storage 240 and non-write-protected storage 230. Write-protected storage 240 may include settings files 250, 252 to store settings values 255, 257. Non-write-protected storage 230 may include a settings file 260 to store a settings value 265. Network interface connector 280 may allow the computer system 205 to communicate across the network 290. The network 290 may be a local area network, a wide area network, a public network, a private network, or any number of other networks. The network 290 may connect to or include the Internet. Non-write-protected storage 235 may be accessible by computer system 205 via network 290. The use may provide authentication, such as a user name and password, for the computer system 205 to access the non-write-protected storage 235 or network 290. Non-write-protected storage 235 may include a settings file 270. Settings file 270 may include settings values 267, 275. Settings value 259 may be accessible by computer system 205 via network 290. Settings value 259 may be pushed across the network 290 to computer system 205 by a systems administrator or automatically downloaded by the settings manager.

Settings file 250 may correspond to a first application to be executed by processor 210. Settings file 252 may correspond to a second application to be executed by processor 210. Computer-readable instructions to execute the first and second application may be stored on storage 220, such as in write-protected storage 240. Computer-readable instructions to execute a settings manager may be stored on storage 220, such as in write-protected storage 240. The settings manager may be an application executed by processor 210.

The settings manager may manage settings corresponding to settings value 255 and settings value 257, corresponding to a first and second application respectively. For example, settings file 250 and settings value 255 may correspond to a word processing application. Settings values 255, 257 may be called existing settings values.

The settings manager may store settings value 265 on non-write-protected storage 230 local to the processor 210, such as connected to the processor 210 via an internal computer bus, small computer system interface (SCSI), Fibre Channel, universal serial bus (USB), or other local connection. The settings manager may store settings values 267, 275 on a remote non-write-protected storage 235, such as a network drive or server accessible over a network 290. For example, settings file 260 may be saved on non-write-protected storage 235. Settings file 270 may be saved on non-write-protected storage 230. Settings values 265, 267, 275 may be stored in settings file 260 or settings file 270. The settings manager may access settings file 260 stored on local non-write-protected storage 230 and also access settings file 270 stored on remote non-write-protected storage 270. Settings values 259, 265, 267, 275 may be called new settings values.

In various examples, a first application may use settings value 255 from settings file 250 during initialization to configure a setting of the first application. A user may modify that setting while using the first application. The settings manager may detect the settings modification and determine that it manages that setting. The settings manager may save a corresponding settings value 275 in a settings file 270 on non-write-protected storage 235. A second application may use settings value 257 from settings file 252 during its initialization to configure a setting of the second application. A user may modify that setting while using the second application. The settings manager may detect the settings modification of the second application and determine it manages that setting. The settings manager may save a corresponding settings value 267 in settings file 270 on non-write-protected storage 235. The settings manager may save settings values corresponding to different applications in the same settings file 270. The computer system 205 may be rebooted and the user may log in and run the first and second applications. The settings manager may detect the initialization of the first application and determine corresponding settings value 275 is stored in settings file 270. The first application may be initialized using settings value 255 from settings file 250. The settings manager may modify the first application's setting from a value corresponding to settings value 255 to a value corresponding to setting value 275. The settings manager may detect initialization of the second application and determine corresponding settings value 267 is stored in settings file 270. The second application may be initialized using settings value 257 from settings file 252. The settings manager may modify the second application's setting from a value corresponding to settings value 257 to a value corresponding to settings value 267. During operation, a user may further change a setting of the first or second application corresponding to settings value 275 or 267, respectively. The settings manager may detect that change and update the settings value 275 or 267 stored in settings file 270. In various examples, the setting may be changed to the value corresponding to settings value 255 or settings value 257. The settings manager may detect that and delete settings value 275 or settings value 267 respectively from settings file 270. In various examples, the settings manager may store a settings value 275 in settings file 270 that corresponds to the same value of settings value 255 in settings file 250. In various examples, settings file 270 may indicate that settings value 275 is not to be used. For example, instead of deleting settings value 275, it may be marked invalid or indicate that the existing settings value, such as settings value 255, should be used.

In various examples, a systems administrator may push a settings change to the computer system 205. The systems administrator may push settings value 259 as a settings change for an application. The application may not be running at the time settings value 259 is pushed. Settings value 259 may correspond to the same setting as settings value 255, but have a different value for that setting. The settings manager may detect the pushed settings value 259 and store settings value 259 in settings file 270. Settings value 259 may be a new entry in settings file 270 or may replace an existing entry in settings file 270, such as settings value 275.

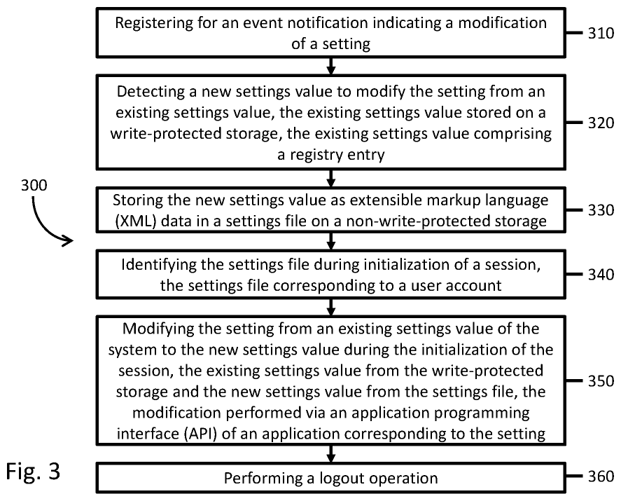

FIG. 3 shows a method 300 of detecting changes of settings corresponding to existing settings values stored on write-protected storage, storing new settings values on non-write-protected storage, and modifying settings during session initialization based on settings values on non-write-protected storage in accordance with various examples. Method 300 may comprise registering for an event notification indicating a modification of a setting 310. Method 300 may comprise detecting a new settings value to modify the setting from an existing settings value, the existing settings value stored on a write-protected storage, the existing settings value comprising a registry entry 320. Method 300 may comprise storing the new settings value as extensible markup language (XML) data in a settings file on a non-write-protected storage 330. Method 300 may comprise identifying the settings file during initialization of a session, the settings file corresponding to a user account 340. Method 300 may comprise modifying the setting from an existing settings value of the system to the new settings value during the initialization of the session, the existing settings value from the write-protected storage and the new settings value from the settings file, the modification performed via an application programming interface (API) of an application corresponding to the setting 350. Method 300 may comprise performing a logout operation 360. Method 300 may be performed by a settings manager.

The format of the settings file used by the settings manager may be in a setup information (INF) format, initialization (INI) format, extensible markup language (XML) format, a JavaScript object notation (JSON) format, a proprietary format, or any number of other formats. In various examples, an XML format may be used. Using XML, the settings file may include sections for different applications or different users. In various examples the settings manager may use multiple settings files. The settings files used by the settings manager may use different settings files for different applications. The settings files used by the settings manager may use different settings files for different users.

When a user logs into a computer system that uses the settings manager, the settings manager may detect which user has logged in. Users may have different settings values corresponding to the same setting of an application. For example, one user may configure a word processing program to default to Courier font, while another user may configure the word processing program to default to Arial font. The settings manager may apply different settings values to the corresponding setting of the word processing program, depending on which user is logged in.

In various examples, modification of a setting by the settings manager may not be finalized until a logout operation is performed. The settings manager may apply the setting and then request a logout operation. The logout may proceed automatically or involve user interaction, such as clicking an acknowledgement or approval button. The setting may finalize its modification once the user logs back in.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A system comprising:
a processor; and
storage coupled to the processor, the storage comprising write-protected storage and non-write-protected storage, the storage to store computer-readable instructions and execution of the computer-readable instructions by the processor causes the processor to:
detect a new settings value to modify a setting from an existing settings value, the existing settings value stored on the write-protected storage; and
store the new settings value in a settings file on the non-write-protected storage.

2. The system of claim 1, wherein the write-protected storage is local to the processor and the non-write protected storage is to communicate with the processor via a network.

3. The system of claim 1, wherein the existing settings value comprises a registry entry.

4. The system of claim 1, wherein the computer-readable instructions are to cause the processor to register for an event notification indicating a modification of the setting.

5. The system of claim 1, wherein the new settings value corresponds to a first application and the settings file comprises a second new settings value corresponding to a second application.

6. A system comprising:
a processor; and
storage coupled to the processor, the storage comprising write-protected storage and non-write-protected storage, the storage to store computer-readable instructions and execution of the computer-readable instructions by the processor causes the processor to:
identify a settings file during initialization of a session, the settings file stored on the non-write-protected storage; and
modify a setting from an existing settings value of the system to a new settings value during the initialization of the session, the existing settings value from the write-protected storage and the new settings value from the settings file.

7. The system of claim 6, wherein the settings file corresponds to a user account.

8. The system of claim 7, wherein the computer-readable instructions are, when executed by the processor, to cause the processor to perform a logout operation.

9. The system of claim 6, wherein the computer-readable instructions are, when executed by the processor, to cause the processor to modify the setting via an application programming interface (API) of an application corresponding to the setting.

10. The system of claim 6, wherein the settings file stores the new settings value as extensible markup language (XML) data.

11. A system comprising:
a processor; and
storage coupled to the processor, the storage comprising write-protected storage and non-write-protected storage, the storage to store computer-readable instructions and execution of the computer-readable instructions by the processor causes the processor to:
detect a new settings value to modify a setting from an existing settings value, the existing settings value stored on the write-protected storage;
store the new settings value in a settings file on the non-write-protected storage; and
modify the setting from the existing settings value to the new settings value during the initialization of the session.

12. The system of claim 11, wherein the computer-readable instructions are to cause the processor to modify a second setting from a second existing settings value to a second new settings value during the initialization of the session, the second new settings value stored in a second settings file on the write-protected storage.

13. The system of claim 12, wherein the computer-readable instructions are to cause the processor to:
receive a third new settings value via a network connection, the third new settings value corresponding to the second setting;
store the third new settings value in the settings file; and
modify the second setting from the second existing settings value to the third new settings value during the initialization of the session.

14. The system of claim 11, wherein the computer-readable instructions are to cause the processor to:
identify a second settings file during initialization of the session; and
modify a second setting from a second existing settings value to a second new settings value during the initialization of the session, wherein the second new settings value is stored in the second settings file, the first settings file is local to the processor, and the second settings file is accessible to the processor via a network connection.

15. The system of claim 11, wherein, to modify the setting, the processor is to modify a registry entry.
